(19) United States
(12) Patent Application Publication
(10) Pub. No.: US 2026/0078618 A1
(43) Pub. Date: Mar. 19, 2026

(54) HANDLE ARRANGEMENT AND VEHICLE DOOR

(71) Applicant: Witte Automotive GmbH, Velbert (DE)

(72) Inventors: Reinaldo MENSCH, Wuppertal (DE); Patrick HANDL, Dormagen (DE); Mohammed HOSSEIN, Düsseldorf (DE)

(21) Appl. No.: 19/331,052

(22) Filed: Sep. 17, 2025

(30) Foreign Application Priority Data
Sep. 18, 2024 (DE) 10 2024 208 905.2

(51) Int. Cl. E05B 81/76

(52) U.S. Cl. CPC E05B 81/77

(57) ABSTRACT

An exterior door handle arrangement may have a handle element, a handle support, a first actuation sensor, which is arranged in an actuating range of the handle element, a second actuation sensor which is or can be arranged on or in a stationary handle component. The two actuation sensors may be signal-coupled to one another such that a trigger signal is or can only be generated when both actuation sensors detect an actuation.

### FIELD

The invention relates to a handle arrangement, in particular an exterior door handle arrangement, and a vehicle door having such a handle arrangement.

### BACKGROUND

Handle arrangements having actuation sensors are well known. Various sensors are known for detecting an actuation and/or approach. For example, sensors are known which activate functions in a vehicle upon actuation, such as generating an unlocking signal to automatically open a trunk or tailgate. Such sensors include, for example, buttons, capacitive sensors, strain gauges and piezo sensors that can identify an actuation and activate a vehicle function. The use of sensors to actuate vehicle functions in vehicle interiors is also known.

Capacitive sensor arrangements are commonly known as proximity sensors or touch sensors for capacitive touch detection. They are used, for example, to detect an approaching hand or hand presence/hand operation on a handle, such as a vehicle exterior handle, and to enable or disable a function, such as a locking or unlocking function.

### SUMMARY

The object of the present invention is to provide an improved handle arrangement with improved functionality and a vehicle door having such an improved handle arrangement.

The first object is achieved according to the invention by a handle arrangement having the features of claim 1. The second object is achieved in accordance with the invention by a vehicle door having the features of claim 10.

The handle arrangement according to the invention comprises at least one handle element, a handle support, a first actuation sensor which is arranged in an actuating range of the handle element and a second actuation sensor which is or can be arranged on or in a stationary handle component.

The two actuation sensors are signal-linked to one another such that a trigger signal is only generated when both actuation sensors detect an actuation. In particular, the two actuation sensors can be configured such that the second actuation sensor only responds, in particular can be activated or detects, when the first actuation sensor has detected an actuation on the handle element.

For example, an evaluation unit can be provided which is signal-coupled to both the first actuation sensor and the second actuation sensor.

The first actuation sensor is, for example, a proximity sensor and/or a touch sensor, in particular a capacitive sensor. The second actuation sensor is, for example, a stroke sensor, in particular a capacitive stroke sensor, an induction sensor, a strain gauge sensor or the like. The second actuation sensor is designed, in particular, to detect the actuation stroke of the handle element as a so-called MoC sensor (with MoC = Metal over Capacitive). The MoC sensor is highly sensitive and configured to detect actuation strokes on the handle element of a few micrometers, in particular greater than 10 micrometers. For example, the MoC sensor detects the actuation force exerted on the handle element, in particular a pressure force, which is fed to a digital processing unit, the evaluation unit, to determine the pressure and, derived therefrom, the actuation stroke. The MoC sensor can, for example, be implemented on a printed circuit board on which the evaluation unit is also implemented.

The advantages achieved by the invention are, in particular, that the handle element does not have to be pressed or pulled at a specific location. Rather, the handle element can be actuated, i.e., pressed or pulled, at any location, since the first actuation sensor first detects an approach to the grip element and/or an actuation, and the second actuation sensor detects the gripping and actuation of the grip element.

For example, the second actuation sensor can be arranged outside the actuating range of the handle element on or in the stationary handle component, in particular a bearing bracket. In particular, the second actuation sensor, designed as a MoC sensor, can be arranged at any location, in particular at a suitable location that is not necessarily gripped and thus lies outside the actuating range of the handle element. In particular, the second actuation sensor can be integrated at a protected location and at a location in the door handle arrangement at which small actuation strokes can be detected. The first actuation sensor is integrated directly in the actuating range, in particular on a front or rear side, of the handle element. Since the first actuation sensor has already detected an approach and/or actuation, and the second actuation sensor is configured to detect particularly small actuation strokes, a reaction can be carried out particularly quickly, in particular the trigger signal for unlocking a door lock can be generated.

The first actuation sensor can have a first measurement sensitivity, and the second actuation sensor a second measurement sensitivity. The measurement sensitivity of the two actuation sensors can, for example, be different from one another.

Furthermore, the door handle arrangement can be formed as an injection-molded component made of a single plastics material. This avoids the need for complex 2K-component parts with soft and hard components.

### DESCRIPTION OF THE FIGURES

Exemplary embodiments of the invention are explained in greater detail with reference to the drawings, in which:

FIG. 1 is a schematic exploded view of a handle arrangement having two actuation sensors, and

FIG. 2 is a schematic view of the handle arrangement in the assembled state.

### DETAILED DESCRIPTION

Parts corresponding to one another are provided with the same reference signs in all the figures.

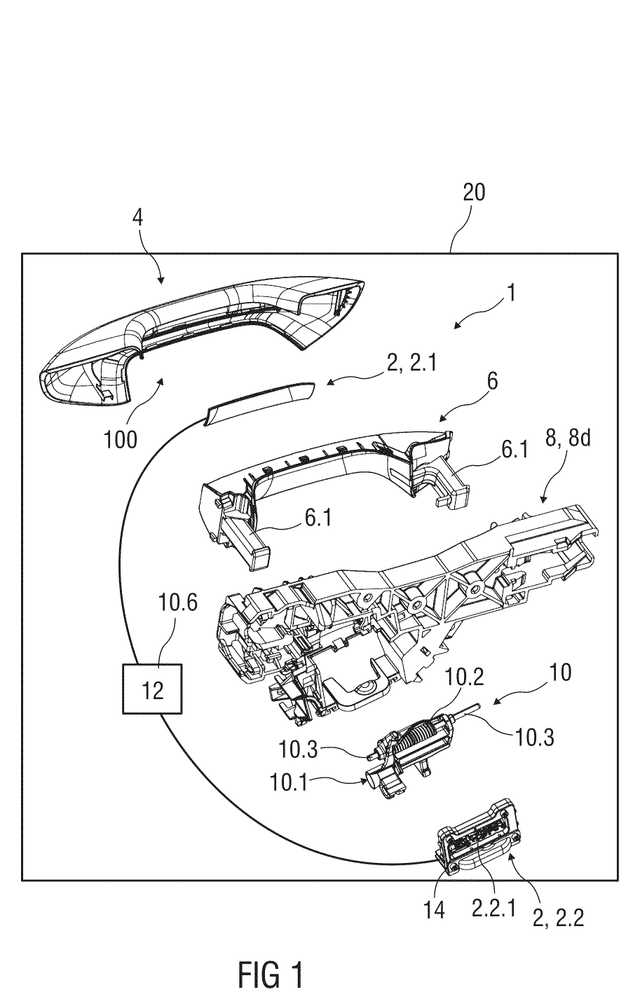

FIG. 1 is a schematic exploded view of a handle arrangement 1 having two actuation sensors 2. The handle arrangement 1 is in particular a door handle arrangement, for example an exterior door handle arrangement, of a vehicle door 20.

The handle arrangement 1 comprises a handle element 4, a handle support 6, a first actuation sensor 2.1 which is arranged in an actuating range 100 of the handle element 4 and a second actuation sensor 2.2 which can be arranged on the handle support 6.

For example, the second actuation sensor 2.2 can be arranged on a stationary handle part or a stationary handle component 8.

For example, the handle arrangement 1 can comprise, as a stationary handle component 8, a bearing bracket 8.1 on which the handle element 4 is movably mounted by means of the handle support 6. For this purpose, the handle support 6 comprises bearing arms 6.1, which are movably mounted on the bearing bracket 8.1. The bearing arms 6.1 are designed, for example, as extension arms and/or articulated arms. The handle element 4 is arranged and held on the handle support 6 in a detachable manner, in particular by means of snap-in connections, clamp connections, clip connections, screw connections or the like.

The bearing bracket 8.1 is held stationary on a vehicle component, in particular a vehicle door 20. The second actuation sensor 2.2 is arranged in or on the bearing bracket 8.1 as a stationary handle component 8.

Additionally or alternatively, a transmission element 10 may be provided, which is arranged between the handle element 4 and the second actuation sensor 2.2.

The two actuation sensors 2 are signal-linked to one another such that a trigger signal 106 is only generated when both actuation sensors 2 detect an actuation of the handle element 4. In particular, the two actuation sensors 2 can be configured such that the second actuation sensor 2.2 only responds, in particular can be activated or detects, when the first actuation sensor 2.1 has detected an approach and/or an actuation on the handle element 4.

For example, an evaluation unit 12 can be provided which can be signal-coupled to both the first actuation sensor 2.1 and the second actuation sensor 2.2. The evaluation unit 12 is, for example, an evaluation electronics unit, in particular an integrated circuit.

The first actuation sensor 2.1 is, for example, a proximity sensor and/or a touch sensor, in particular a capacitive sensor, an induction sensor, a strain gauge sensor or the like.

The second actuation sensor 2.2 is, for example, a stroke sensor, in particular a capacitive stroke sensor (also called a displacement sensor or force-displacement sensor), an induction sensor, a strain gauge sensor or the like. The second actuation sensor 2.2 is designed, in particular, to detect an actuation stroke of the handle element 4 as a so-called MoC sensor (with MoC = Metal over Capacitive). The MoC sensor is highly sensitive and configured to detect actuation strokes on the handle element 4 of a few micrometers, in particular greater than 10 micrometers. For example, the MoC sensor detects the actuation force exerted on the handle element 4, in particular a pressure force, which is fed to the evaluation unit 12 to determine the pressure and, derived therefrom, the actuation stroke.

The second actuation sensor 2.2 can, for example, be implemented on a printed circuit board 14 on which the evaluation unit 12 can also be implemented.

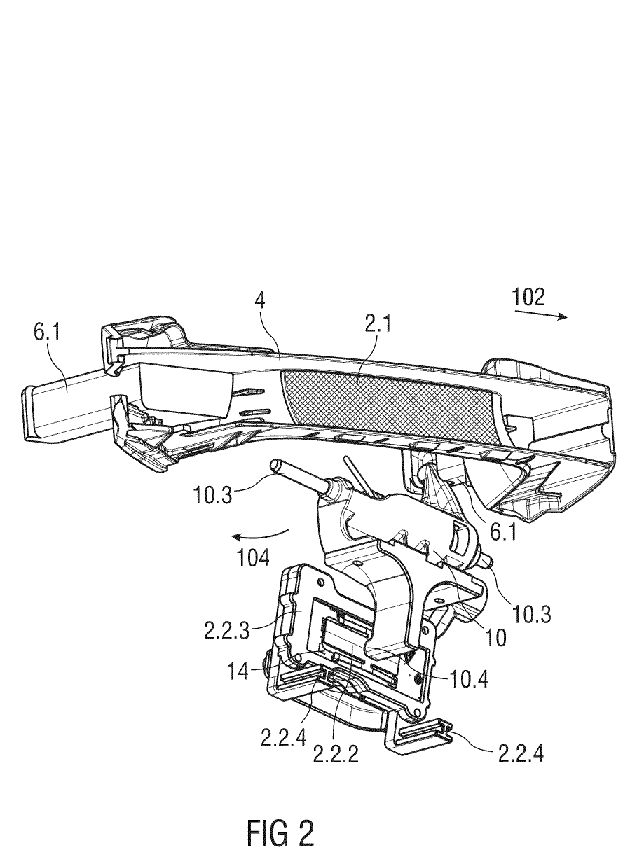

The second actuation sensor 2.2 is designed as a sensor module which comprises the printed circuit board 14 as a support for the arrangement of a stationary sensor electrode 2.2.1 of the second actuation sensor 2.2. A movable sensor electrode 2.2.2 (shown in FIG. 2) of the second actuation sensor 2.2 is arranged at a distance from the stationary sensor electrode 2.2.1, for example on the optional transmission element 10 or on the printed circuit board 14, in particular movably mounted or correspondingly flexibly configured. The stationary sensor electrode 2.2.1 and/or the printed circuit board 14 are arranged and held or fastened to the stationary handle component 8, in particular to the bearing bracket 8.1.

When the handle element 4 is actuated, a movement carried out in the process can, for example, directly control the actuation sensors 2.1, 2.2 or optionally be transmitted to them via the transmission element 10, so that the movable sensor electrode 2.2.2 moves relative to the stationary sensor electrode 2.2.1 on the printed circuit board 14 directly as a result of the handle actuation or optionally as a result of the movement of the transmission element 10, or the movement of the transmission element 10 actuates the movable sensor electrode 2.2.2 so that it moves relative to the stationary sensor electrode 2.2.1.

The advantages achieved by the invention are, in particular, that the handle element 4 does not have to be pressed or pulled at a specific location. Rather, the handle element 4 can be actuated, i.e., pressed or pulled, at any location, since the first actuation sensor 2.1 has already detected an approach to the handle element 4 and/or an actuation, and the second actuation sensor 2.2 detects the gripping and actuation of the handle element 4 directly or indirectly.

The first actuation sensor 2.1 is integrated directly in the actuating range 100, in particular in the region of a handle recess on a front or a rear side of the handle element 4. Alternatively, the first actuation sensor 2.1 in the actuating range 100 can also be integrated on the handle support 6 or on the bearing bracket 8.1.

The first actuation sensor 2.1 is integrated in particular as a film sensor into a surface of the front or the rear side of the handle element 4. For example, the first actuation sensor 2.1 is designed as an ultra-thin film printed with capacitive sensor fields and incorporated into a surface, in particular into a lacquer layer.

Since the first actuation sensor 2.1 has already detected an approach and/or actuation and the second actuation sensor 2.2 is configured to detect particularly small actuation strokes, a reaction can be carried out particularly quickly, in particular the trigger signal 106 for unlocking a door lock can be generated.

In particular, the second actuation sensor 2.2, designed as a MoC sensor, can be arranged at any location, in particular at a suitable location that is not necessarily gripped and thus lies outside the actuating range 100 of the handle element 4. For example, the second actuation sensor 2.2 can be integrated at a protected location and at a location in the handle arrangement 1 at which small actuation strokes can be detected.

The second actuation sensor 2.2, designed as a MoC sensor, can, for example, be integrated, in particular mounted, at a suitable location in or on the bearing bracket 8.1. This can be, for example, on an inward-facing rear side of the bearing bracket 8.1 or at a position in the handle arrangement 1 that is favorable for the design.

To detect the actuation stroke of the handle element 4 by means of the second actuation sensor 2.2, direct control is provided by the handle movement itself, or optionally, force can be transmitted from the actuation stroke of the handle element 4 relative to the stationary bearing bracket 8.1 using the transmission element 10, which is arranged between the bearing bracket 8.1 and the second actuation sensor 2.2. The optional transmission element 10 is designed, for example, as a lever mechanism, in particular as a bell crank 10.1. The bell crank 10.1 is spring-loaded and rotatably mounted on the bearing bracket 8.1. For example, a return spring 10.2 is arranged on the optional transmission element 10 for automatically resetting the transmission element 10 when the handle element 4 is released. Furthermore, the bell crank 10.1 comprises bearing pins 10.3 by means of which the bell crank 10.1 is rotatably mounted on the bearing bracket 8.1.

The first actuation sensor 2.1, designed as a capacitive sensor, is positioned in the actuating range 100 such that the approach of a user or an intentional actuation is or can be detected. The evaluation of the events and/or the differentiation between an intentional actuation and an unintentional actuation is carried out by means of a corresponding evaluation electronics unit of the evaluation unit 12. An intentional actuation is determined, in particular validated, by evaluating both signal sources, for example, by a sensor fusion of the first actuation sensor 2.1, designed as a capacitive sensor, and the second actuation sensor 2.2, designed as a force-displacement sensor, in particular a MoC sensor. This information from the two actuation sensors 2 can be logically linked by means of an AND gate. In other words: only if both actuation sensors 2 detect and output a valid signal, in particular simultaneously, is this recognized as an intentional actuation by the evaluation unit 12, and the corresponding trigger signal 106, for example for unlocking the vehicle lock, is generated by means of the evaluation unit 12 and transmitted to an unlocking of the vehicle lock. Such a sensor fusion of both actuation sensors 2 leads to a more robust and reliable detection of an actuation on the handle arrangement 1 and simultaneously offers greater design freedom.

FIG. 2 schematically shows the handle arrangement 1 without the bearing bracket 8.1 and without the handle element 4 in the assembled state.

The first actuation sensor 2.1 is integrated into the handle element 4. One of the bearing arms 6.1 is motion-coupled to the transmission element 10. For example, the bearing arm 6.1 and the transmission element 10 are connected to one another by means of a plug connection 16. The second actuation sensor 2.2 is designed as a sensor module with a sensor housing 2.2.3 in which the printed circuit board 14 is held. The transmission element 10 is rotatably mounted on the stationary handle component 8, in particular on the bearing bracket 8.1 (shown in FIG. 1). For this purpose, the transmission element 10 comprises, for example, the bearing pins 10.3.

The sensor housing 2.2.3 is easily mounted, in particular pluggable, onto the bearing bracket 8.1. For example, the sensor housing 2.2.3 comprises at least one corresponding guide member 2.2.4, for example a pair of guide members 2.2.4, which can be inserted, in particular plugged, into corresponding counter-guide members on the bearing bracket 8.1.

The transmission element 10 may in turn comprise a stamp 10.4 which extends in the direction of the movable sensor electrode 2.2.2. When the handle element 4 is actuated in accordance with arrow 102, the transmission element 10 is moved in accordance with arrow 104, in particular pivoted in the direction of the movable sensor electrode 2.2.2, so that the movable sensor electrode is actuated and moves relative to the stationary sensor electrode 2.2.1. This actuation stroke is detected by means of the evaluation unit 12 and fused with the sensor signal of the first actuation sensor 2.1 and, upon reliable detection of an actuation, the trigger signal is generated.

### LIST OF REFERENCE SIGNS

1 Handle arrangement

2 Actuation sensor

2.1 First actuation sensor

2.2 Second actuation sensor

2.2.1 Stationary sensor electrode

2.2.2 Movable sensor electrode

2.2.3 Sensor housing

2.2.4 Guide member

4 Handle element

6 Handle support

6.1 Bearing arm

8 Stationary handle component

8.1 Bearing bracket

10 Transmission element

10.1 Bell crank

10.2 Return spring

10.3 Bearing pins

10.4 Stamp

12 Evaluation unit

14 Printed circuit board

16 Plug connection

20 Vehicle door

100 Actuating range

102 Arrow

104 Arrow

106 Trigger signal

1. An exterior door handle arrangement, comprising:
a handle element,
a handle support,
a first actuation sensor which is arranged in an actuating range of the handle element, and
a second actuation sensor which is or can be arranged on or in a stationary handle component, wherein the two actuation sensors are signal-coupled to one another such that a trigger signal is or can only be generated when both actuation sensors detect an actuation.

2. The handle arrangement according to claim 1, wherein the second actuation sensor only generates the trigger signal if the first actuation sensor has already detected an actuation and/or an approach.

3. The handle arrangement according to claim 1, further comprising an evaluation unit which is signal-coupled to both the first actuation sensor and the second actuation sensor.

4. The handle arrangement according to claim 1, wherein the first actuation sensor is a proximity sensor and/or a touch sensor.

5. The handle arrangement according to claim 1, wherein the first actuation sensor is a capacitive sensor.

6. The handle arrangement according to claim 1, wherein the second actuation sensor is a stroke sensor.

7. The handle arrangement according to claim 1, wherein the second actuation sensor is a capacitive stroke sensor.

8. The handle arrangement according to claim 1, wherein the first actuation sensor has a first measurement sensitivity and the second actuation sensor has a second measurement sensitivity.

9. The handle arrangement according to claim 1, wherein the second actuation sensor is arranged outside the actuating range of the handle element in the stationary handle component.

10. A vehicle door having a handle arrangement according to claim 1.
